(19) United States
(12) Patent Application Publication
(10) Pub. No.: US 2012/0294626 A1
(43) Pub. Date: Nov. 22, 2012

(54) METHOD TO ASSIGN A CUSTOMER PREMISES EQUIPMENT TO A SUBSCRIBER'S DATA RECORD, DEMARCATION POINT UNIT, AND NETWORK ELEMENT

(75) Inventors: Joerg Hehmann, Weil Der Stadt (DE); Michael Straub, Maulbronn (DE)

(73) Assignee: ALCATEL-LUCENT, Paris (FR)

(21) Appl. No.: 13/574,361

(22) PCT Filed: Feb. 1, 2011
(86) PCT No.: PCT/EP2011/051389

§ 371 Date: Jul. 20, 2012

(30) Foreign Application Priority Data
Feb. 26, 2010 (EP) 10305195.9

(51) Int. Cl. H04B 10/00

(52) U.S. Cl. 398/167.5

(57) ABSTRACT

The invention relates to a method for a telecommunication's network with a central office (CO), an access network, a multiple of demarcation point units (DPUn) and customer premises equipment (ONTn) connected thereto, to assign a customer premises equipment (ONTn) to a subscriber's data record registered in the central office (CO), where when a customer premises equipment (ONTn) reports the received signal amplitude in regular reporting intervals to the central office (CO), a customer premises equipment (ONTn) is assigned to a subscriber's data record by uniquely influencing the signal amplitude by the demarcation point unit (DPUn) assigned to the customer premises equipment (ONTn), the assignment of which to a certain subscriber's data record is known in the central office (CO), where the influencing of the signal amplitude is performed such that a digital signature proper to the demarcation point unit (DPUn) is imprinted on the signal amplitude, where the bit clock underlying the signature is adapted to the reporting intervals, and that the central office (CO) recovers the signature of the demarcation point unit (DPUn) from the sequence of signal amplitudes reported from the customer premises equipment (ONTn) and derives therefrom the assignment between customer premises equipment (ONTn) and subscriber's data record, as well as to a demarcation point unit, and to a network element.

The invention relates to a method to assign a customer premises equipment to a subscriber's data record according to the preamble of claim 1, to a demarcation point unit according to the preamble of claim 4, and to a network element for a central office, according to the preamble of claim 5.

Such telecommunication's networks are well known, for example from EP 1 986 351 A1, and EP 2 015 480 A1.

Both, optical and wireless access networks normally are point-to-multipoint networks. Each customer has a connection point, where he or she can connect whatever customer premises equipment like simple telephones, servers, or multimedia devices. Such connecting equipment is being done by the customer himself or herself and can also be changed at whatever time. There is a need to register the used equipment in the central office of the network operator and to unambiguously assign it to a subscriber's data record.

To this end it is known that the customer performs a certain procedure, in the course of which a code received from the operator is to be entered. Such registration procedure is time consuming, cumbersome and error-prone.

The invention deals with the problem of providing a method and respective devices to assign a customer premises equipment to a subscriber's data record registered in the central office of the network operator.

This problem according to the invention is solved by a method according to the teaching of claim 1, by a network terminating unit according to the teaching of claim 4, and by a network element for a central office, according to the teaching of claim 5.

The invention makes use of two circumstances:

On the one hand network operators often insist on terminating their network with each customer by a device being separated from any customer's devices and being in their own responsibility. It is known also that such units, then called demarcation point units, also are assigned unambiguous and individual identifiers. Such demarcation point units are installed under the responsibility of the network operator, who thus knows the customer in whose location such demarcation point unit is installed. The classical network terminating element called Network Termination thus is separated into two parts. One part, the Optical Network Termination, physically is terminating the network, but is in the responsibility of the subscriber; the other part, the Demarcation Point Unit, is terminating the responsibility of the operator.

On the other hand any customer premises equipment foreseen for connecting to an optical access line nowadays is built such that, when in operation, it regularly reports the received signal amplitude to the central office, to which it is connected.

The inventors' idea now is to impose the demarcation point unit's identifier on the signal coming from the central office to the customer's device by influencing the signal amplitude of this signal and have it reported to the central office. Of course the chronological sequence of the imposing of the identifier has to be adapted to the reporting intervals of the customer's device.

Further embodiments of the invention can be found in the sub-claims and in the accompanying description.

In the following the invention will be described with reference to the accompanying drawing, in which

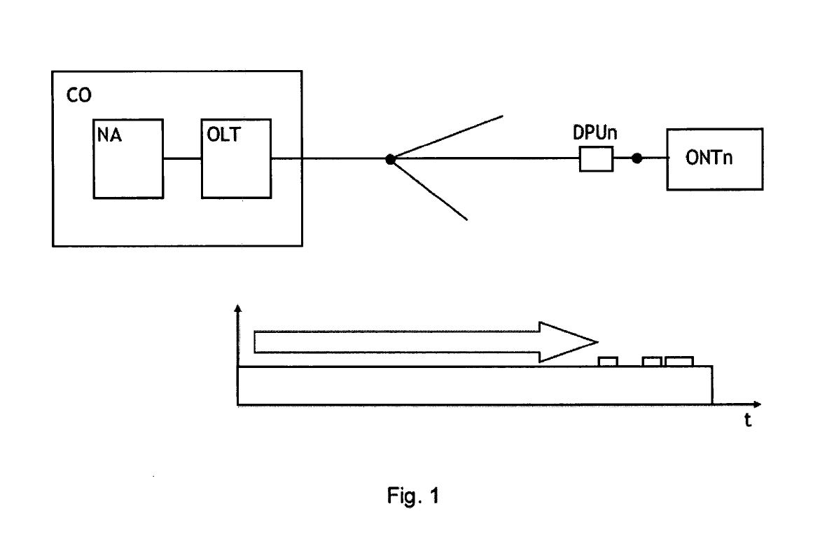

FIG. 1 shows a telecommunication's network, in which a method according to the invention can be performed.

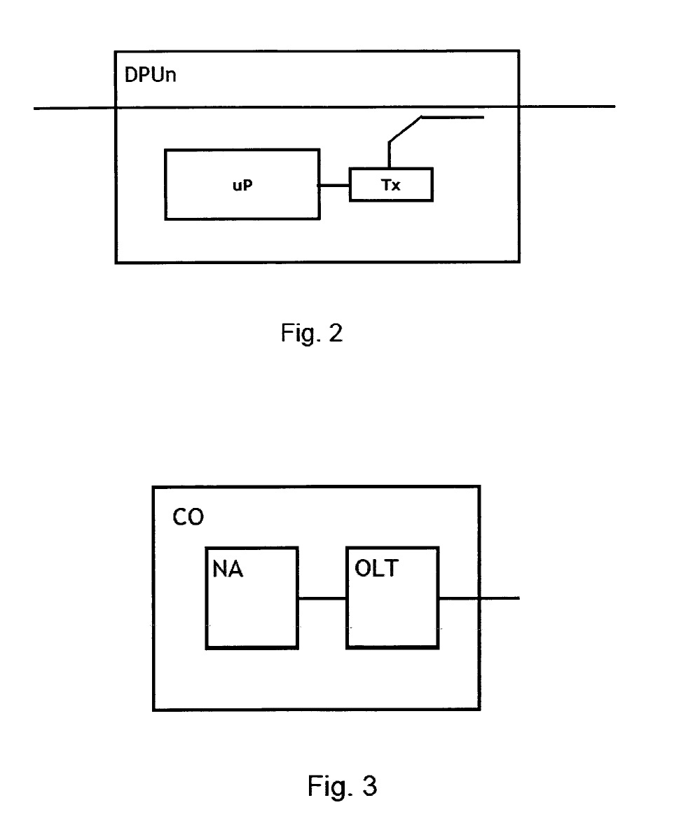

FIG. 2 shows a demarcation point unit according to the invention.

FIG. 3 shows a central office including a network analyzer as an example of a network element according to the invention.

FIG. 1 shows both, a telecommunication's network, and a diagram representing the signal flow therein.

The telecommunication's network includes a central office CO, an access network, not labeled, a demarcation point unit DPUn representing one of a multiple of network terminating units, and an optical network termination unit ONTn representing a subscriber's customer premises equipment.

The central office CO here is shown as including an optical line termination unit OLT and a network analyzer NA.

The optical line termination unit OLT performs the conversion between optical and electrical part and the transmission technological functions like adapting power levels.

The network analyzer NA performs some kind of network operation tasks.

It is to be noticed, that in practical realization the network analyzer NA as mentioned above often is spatially separated from the optical line termination unit OLT and then mostly is a network element in common to more than one optical line termination unit OLT. This does not influence the idea of the invention.

The signal flow represented thereunder is a signal flow from the optical line termination unit OLT within the central office CO to the optical network termination unit ONTn. From the demarcation point unit DPUn on additional signal elements are added imposed by the demarcation point unit DPUn.

This signal flow representation is by no means to scale: The duration of either of the imposed signal elements has nothing to do with the propagation time it undergoes. The clock of the signal from the optical line termination unit OLT is such high in relation to the clock of the imposed signal elements from the demarcation point unit DPUn, that it is not even represented. The relation between the amplitude of the signal from the optical line termination unit OLT to the imposed signal elements from the demarcation point unit DPUn is small, namely in the range of some few percents, not more than 20% but rather in the range of 5%. The attenuation of the signal on its way from the optical line termination unit OLT to the optical network termination unit ONTn is not represented either.

The additional signal elements imposed by the demarcation point unit DPUn represent the unambiguous and individual identifier assigned to exactly this demarcation point unit DPUn. It thus represents a digital signature proper to this demarcation point unit DPUn.

The amplitude of these additional signal elements on the one hand has to be chosen such that it can be clearly detected by a transceiver parameter monitor allegedly being part of the network termination unit ONTn. On the other hand this amplitude is to be kept such low that the regular data flow between the optical line termination unit OLT and the optical network termination unit ONTn is not disturbed.

The same considerations concerning the relation between the amplitude of the signal from the optical line termination unit OLT and the imposed signal elements from the demarcation point unit DPUn apply when the signal elements from the demarcation point unit DPUn are imposed by attenuating the signal from the optical line termination unit OLT within the demarcation point unit DPUn.

Increasing the overall signal amplitude requires an optical signal source like a laser or a light emitting diode. Reducing the overall signal amplitude requires some kind of a switchable attenuator like a coupler with a coupling factor that can be influenced or either of the terminations of which can be switched.

The clock with which such signature is to be imposed onto the signal flow has to be such low, that it is ensured that the transceiver parameter monitor in the optical network termination unit ONTn while performing its monitoring and reporting task for sure also monitors and reports the variations recognized. This clock therefor has to be adapted to the reporting intervals of such transceiver parameter monitor such that the reporting intervals are not shorter than one bit of the signature imposed.

FIG. 2 shows an example of such demarcation point unit DPUn according to the invention. The optical line between the central office CO and the network termination unit ONTn within the subscriber's customer premises equipment is looped through through this demarcation point unit DPUn, shown as drawn through line. The demarcation point unit DPUn further includes a control element, here designated as uP, a usual abbreviation of a microprocessor, an optical transmitter Tx, and an optical coupler coupling the optical transmitter Tx to the looped through optical line.

The use of a microprocessor uP as control element is justified by other tasks such demarcation point unit DPUn normally is to perform. To this end it might also be coupled to the looped through optical line with receiving means for receiving data from either of both directions or with means for also transmitting towards the central office.

In principle the invention works, when the demarcation point unit DPUn continuously imposes its signature on the signal flow. Depending on the intelligence provided by the control element and on the way it is coupled to the optical line, the imposing the signature could be limited to short periods at the beginning of communications or on demand from the central office.

FIG. 3 shows a central office CO including a network analyzer NA as an example of a network element according to the invention.

As already previously mentioned the central office CO here is shown as including an optical line termination unit OLT and network analyzer NA.

The optical line termination unit OLT performs the conversion between optical and electrical part and the transmission technological functions like adapting power levels.

The network analyzer NA performs some kind of network operation tasks.

The optical line termination unit OLT needs not to vary from known such optical line termination units. There is only a need to adapt the network analyzer NA in the central office, such that from the parameters reported from the customer premises' equipment, especially the received power levels, the signature of the assigned known demarcation point unit DPUn can be derived and thereby the customer premises equipment can be assigned to the respective subscriber's data record.

As already mentioned it is to be noticed, that in practical realization the network analyzer NA as mentioned above often is spatially separated from the optical line termination unit OLT and then mostly is a network element in common to more than one optical line termination unit OLT and more than one central office.

1. Method for a telecommunication's network with a central office, an access network, a multiple of demarcation point units and customer premises equipment connected thereto, to assign customer premises equipment to a subscriber' data record registered in the central office, wherein when a customer premises equipment reports received signal amplitudes in regular reporting intervals to the central office, a customer premises equipment is assigned to a subscriber's data record by uniquely in fluencing the signal amplitude by the demarcation point unit assigned to the customer premises equipment, the assignment of which to a certain subscriber's data record is known in the central office, where the influencing of the signal amplitude is performed such that a digital signature individually assigned to the demarcation point unit is imprinted on the signal amplitude, where the bit clock underlying the signature is such that one bit of the signature imposed is at least as long as a reporting interval, and that the central office recovers the signature of the demarcation point unit from the sequence of signal amplitudes reported from the customer premises equipment and derives therefrom the assignment between customer premises equipment and subscriber's data record.

2. Method according to claim 1, wherein the demarcation point unit influences the signal amplitude by additively adding the signature as supplementary signal with an amplitude being small compared to the signal amplitude.

3. Method according to claim 1, wherein the demarcation point unit influences the signal amplitude by attenuating the signal amplitude by a small amount according to the signature.

4. Demarcation point unit for a telecommunication's network with a central office, an access network, a multiple of demarcation point units and customer premises equipment connected thereto, where customer premises equipment report received signal amplitudes in regular reporting intervals to the central office, wherein the demarcation point unit is built such that the demarcation point unit is in position to uniquely influence the amplitude of a signal from the central office to a customer premises equipment connected to the demarcation point unit, where the influencing of the signal amplitude is performed such that a digital signature individually assigned to the demarcation point unit is imprinted on the signal amplitude using a bit clock underlying the signature that is such that one bit of the signature imposed is at least as long as a reporting interval.

5. Network element for a central office for a telecommunication's network with a central office, an access network, a multiple of demarcation point units and customer premises equipment connected thereto, wherein the network element is built such that the network element is in position to recover a signature of a demarcation point unit from the sequence of signal amplitudes reported from a customer premises equipment and to derive therefrom the assignment between customer premises equipment and subscriber's data record.
